(19) United States
(12) Patent Application Publication
(10) Pub. No.: US 2013/0015406 A1
(43) Pub. Date: Jan. 17, 2013

(54) GAS DEACIDIZING METHOD USING AN ABSORBENT SOLUTION WITH RELEASE OF A GASEOUS EFFLUENT FROM THE ABSORBENT SOLUTION AND WASHING OF THE EFFLUENT WITH THE REGENERATED ABSORBENT SOLUTION

(71) Applicants: Jeremy Gazarian, Condrieu (FR); Pierre-Antoine Bouillon, Lyon (FR); Marc Jacquin, Lyon (FR)

(72) Inventors: Jeremy Gazarian, Condrieu (FR); Pierre-Antoine Bouillon, Lyon (FR); Marc Jacquin, Lyon (FR)

(21) Appl. No.: 13/577,686

(22) PCT Filed: Jan. 20, 2011
(86) PCT No.: PCT/FR2011/000036

§ 371 Date: Sep. 26, 2012

(30) Foreign Application Priority Data
Feb. 8, 2010 (FR) 1000492

(51) Int. Cl. B01D 53/40; C10L 3/10; C01B 3/52

(52) U.S. Cl. 252/373; 423/210

(57) ABSTRACT

The invention relates to a method for deacidizing a gas feed comprising acid compounds.

The gas feed is contacted in C1 with an absorbent solution so as to obtain a gaseous effluent depleted in acid compounds and an absorbent solution laden with acid compounds, the absorbent solution being selected for its property of forming two liquid phases when heated. A gaseous effluent is then released from the absorbent solution laden with acid compounds. At least part of the absorbent solution laden with acid compounds is thermally regenerated and at least a fraction of the regenerated absorbent solution is separated into a water-enriched liquid phase and a liquid phase enriched in reactive compounds. The water-enriched liquid phase is used to wash the gaseous effluent released from the absorbent solution enriched in acid compounds in order to obtain a gaseous effluent depleted in reactive compounds.

### FIELD OF THE INVENTION

The present invention relates to the field of deacidizing a gas feed by means of an absorbent solution.

The method according to the invention allows to remove acid compounds such as carbon dioxide (CO₂) and hydrogen sulfide (H₂S) contained in a gas feed. It can be applied for treating a natural gas, a syngas or fumes from a combustion process.

### BACKGROUND OF THE INVENTION

Document FR-2,898,284 aims to use a demixing absorbent solution having the property of splitting up when said absorbent solution laden with acid compounds is heated. The absorbent solution is contacted with the gas feed to be deacidized. During regeneration, the solution divides into two phases: a fraction rich in acid compounds and a fraction poor in acid compounds. Thus, the method according to document FR-2,898,284 aims to regenerate by distillation only the fraction that is laden with acid compounds in order to minimize the energy required for regeneration of the absorbent solution.

In cases where absorption is carried out under high pressure, for example in the case of natural gas treatment, the absorbent solution laden with acid compounds is first expanded in a drum in order to separate part of the acid compounds in gas form and to release co-absorbed natural gas, generally hydrocarbons. During this expansion stage, a portion of the absorbent solution can be carried along mechanically and thermodynamically by the expansion gas.

The present invention provides a new configuration for washing a gas released from an absorbent solution laden with acid compounds. The method according to the invention affords the advantage of preventing losses and discharge of reactive compounds from the absorbent solution.

### SUMMARY OF THE INVENTION

In general terms, the invention describes a method of deacidizing a gas feed comprising at least one acid compound of the group made up of hydrogen sulfide (H₂S) and carbon dioxide (CO₂), wherein the following stages are carried out:
a) contacting said feed with an absorbent solution comprising at least one reactive compound so as to obtain a gaseous effluent depleted in acid compounds and an absorbent solution laden with acid compounds, the absorbent solution being selected for its property of forming two liquid phases when heated,
b) releasing a gaseous effluent comprising acid compounds from the absorbent solution laden with acid compounds,
c) thermally regenerating at least part of the absorbent solution obtained in stage (b) so as to release the acid compounds in gas form and to obtain a regenerated absorbent solution,
d) recycling at least a first fraction of the regenerated absorbent solution obtained in stage (c) as the absorbent solution of stage (a),
e) separating at least a second fraction of the regenerated absorbent solution obtained in stage (c) into a water-enriched liquid phase and a liquid phase enriched in reactive compounds,
f) contacting the gaseous effluent obtained in stage (b) with said water-enriched liquid phase so as to obtain a gaseous effluent depleted in reactive compounds.

According to the invention, stage (b) can be carried out by heating the absorbent solution laden with acid compounds.

Furthermore, the method according to the invention can comprise a stage of separating the heated absorbent solution into a liquid phase depleted in acid compounds and a liquid phase enriched in acid compounds; the liquid phase enriched in acid compounds can be recycled to stage (c) and the liquid phase depleted in acid compounds can be recycled to stage (d).

Advantageously, the heating stage can be carried out at a temperature ranging between 50° C. and 150° C.

According to another variant of the invention, stage (b) can be carried out through expansion of the absorbent solution laden with acid compounds.

Furthermore, the method according to the invention can comprise, prior to stage (f), a washing stage wherein the gaseous effluent is contacted with the liquid phase enriched in acid compounds obtained in stage (e) mixed with the water-enriched liquid phase from stage (f) so as to obtain a gaseous effluent depleted in acid compounds.

Besides, in the method according to the invention, the water-enriched liquid phase can be recovered at the end of stage (f).

In a variant of the invention, a fraction of the water-enriched liquid phase obtained at the end of washing stage (f) can be recycled to stage (f).

In another variant of the invention, a fraction of the water-enriched liquid phase obtained at the end of washing stage (f) can be recycled to stage (d) of the method.

Advantageously, the separation stages can be conducted according to one of the following separation techniques: decantation, centrifugation or filtration.

According to the invention, at least one reactive compound of the absorbent solution can be selected from the group consisting of amines, alkanolamines, polyamines, amino-acids, amino-acid alkaline salts, amides, ureas, alkali metal phosphates, carbonates and borates.

According to the invention, said gas feed can be selected from the group made up of natural gas, syngas, combustion fumes, refinery gas, Claus tail gas and biomass fermentation gas.

### BRIEF DESCRIPTION OF THE FIGURES

Other features and advantages of the invention will be clear from reading the description hereafter, with reference to the accompanying figures wherein:

FIG. 1 shows the method according to the invention,

FIG. 2 shows a gas deacidizing method using an absorbent solution according to the prior art,

FIG. 3 illustrates a demixing phenomenon of an absorbent solution used in the method according to the invention,

FIG. 4 illustrates a variant of the method according to the invention.

### DETAILED DESCRIPTION

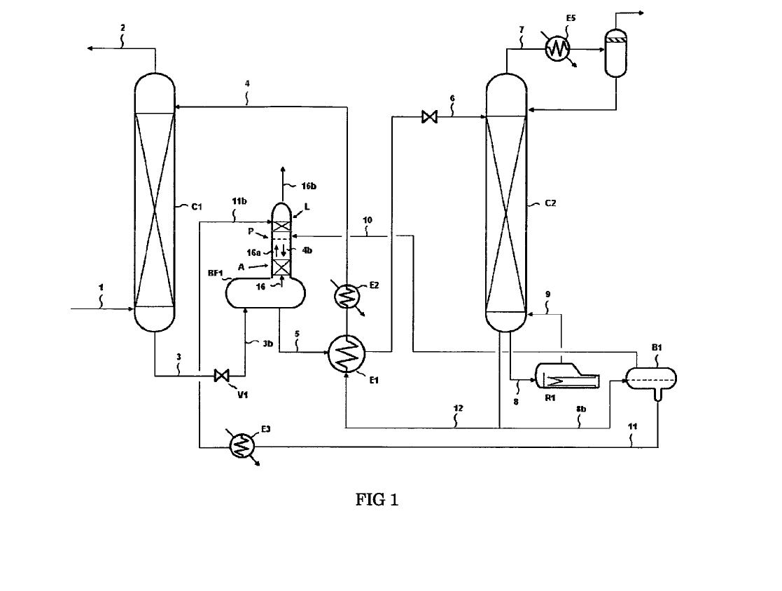

With reference to FIG. 1, the gas feed to be deacidized circulating in line 1 is contacted in column C1 with the absorbent solution flowing in through line 4. Column C1 is equipped with gas/liquid contacting internals, for example distillation trays, a random or a stacked packing. Column C1 can operate at a temperature ranging between 30° C. and 90° C., preferably between 40° C. and 70° C., and at a pressure ranging between 2 and 100 bars absolute, preferably between 20 and 80 bars absolute.

The deacidizing method according to the invention can be applied to various gas feeds. For example, the method allows to decarbonate combustion fumes, to deacidize natural gas or a Claus tail gas. The method also allows to remove the acid compounds contained in syngas, in conversion gas, in integrated coal or natural gas combustion plants, and in the gas resulting from biomass fermentation. In the sense of the present invention, “acid compounds” are understood to be CO₂ and/or H₂S.

In the absorption section, the reactive compounds of the absorbent solution react with the acid compounds to be collected so as to form a salt soluble in the solution. The gas depleted in acid compounds is discharged at the top of the section via line 2.

The absorbent solution laden with acid compounds in form of salts dissolved in water is discharged from column C1 at the bottom through line 3. The absorbent solution is an aqueous solution comprising one or more reactive compounds having a physico-chemical affinity with acid compounds. An absorbent solution comprising compounds that react in a reversible manner with acid compounds such as H₂S and CO₂ is selected. According to the invention, one selects one or more reactive compounds having the property, in aqueous phase, of forming two separable liquid phases when the temperature is above a critical temperature. In other words, the reactive compound(s) of the absorbent solution are selected in such a way that the regenerated absorbent solution comes in two-phase form when its temperature exceeds a critical demixing temperature, i.e. a temperature threshold. The reactant(s) are so selected that the regenerated absorbent solution forms a liquid phase rich in reactive compounds and a water-rich liquid phase when the temperature of the regenerated absorbent solution exceeds the critical demixing temperature. The composition of the absorbent solution used in the method according to the invention is detailed hereafter.

In some cases, expansion of the absorbent solution laden with acid compounds is useful for releasing a fraction of the acid compounds and a possibly co-absorbed gas fraction (hydrocarbons, hydrogen, etc.). The present invention aims to recover the co-absorbed gases released during the expansion stage. Stream 3 is then expanded through valve V1 and sent to a flash drum BF1 via line 3b. The gas released upon expansion, referred to hereafter as expansion gas (16), consists of a gas fraction comprising acid compounds such as CO₂ or H₂S (referred to as acid gas hereafter). When the gas feed is natural gas, the expansion gas also consists of a gas fraction of co-absorbed hydrocarbons. The expansion stage is conducted under conditions known to the person skilled in the art. The absorbent solution laden with acid compounds circulating in line (3b) can be expanded at a pressure ranging between 0.2 and 5 MPa, preferably between 0.5 and 1.5 MPa. Flash drum BF1 therefore operates at a pressure ranging between 0.2 and 5 MPa, preferably between 0.5 and 1.5 MPa.

With reference to FIG. 1, flash drum BF1 is provided with a washing section A for reducing the proportion of acid compounds in expansion gas 16. Washing section A is equipped with gas/liquid contacting internals, for example distillation trays, a random or a stacked packing. The expansion gas is washed through contact, possibly countercurrent, with a liquid mixture (4b) described hereafter. A stream of gas depleted in acid compounds (16a) is obtained.

The gas depleted in acid compounds (16a) can contain a significant proportion of reactive compounds. In fact, at the top of washing section A, liquid mixture (4b) flows countercurrent to a gas circulating at high velocity. This contacting results in a fraction of the reactive compounds contained in mixture (4b) being subjected to a strong mechanical entrainment by the gas. Furthermore, depending on the temperature at this point of the washing section, the reactive compounds can also be entrained thermodynamically in the gas depleted in acid compounds. According to the invention, a specific washing section L is used to prevent reactive compound losses and discharge. Washing section L is equipped with gas/liquid contacting internals, for example distillation trays, a random or a stacked packing. In section L, gas (16a) is contacted with the water-enriched liquid phase flowing in through line 11b. The water-enriched liquid phase is described hereafter. It allows to capture and to remove the reactive compounds entrained by the gas upon passage through washing section A. A liquid phase enriched in water and in reactive compounds is obtained at the outlet of this washing section L, as well as a gaseous effluent depleted in reactive compounds that is discharged through line (16b). The liquid phase enriched in water and in reactive compounds is then mixed with the liquid phase enriched in reactive compounds of the regenerated absorbent solution from drum B1, flowing into flash drum BF1 through line 10. These two phases form liquid mixture (4b). This mixture (4b) is contacted with expansion gas (16) in washing section A and allows it to be washed. The liquid obtained in the bottom of BF1 is discharged through line 5 to exchanger E1, then to C2 in order to be regenerated. This liquid is referred to, in the rest of the description, as an absorbent solution laden with acid compounds. The absorbent solution leaving E1 is fed, after expansion, through line 6 to column C2 where it is thermally regenerated.

Thermal regeneration can be distillation or steaming of the acid compounds, an operation commonly referred to as stripping. Column C2 is equipped with a reboiler R1 and with gas/liquid contacting internals. Column C2 can operate at a temperature ranging between 80° C. and 200° C., preferably between 100° C. and 160° C., and at a pressure ranging between 1 bar and 10 bars absolute, preferably between 1.5 bars and 7 bars absolute. In C2, the reactive compounds of the absorbent solution are separated from the acid compounds. The acid compounds are released in gas form and discharged from C2 through line 7. Steam stream 7 rich in acid compounds is partly condensed by cooling in exchanger E5 and the condensates are sent to the top of C2 as reflux.

A fraction of the absorbent solution is withdrawn from the bottom of column C2 through line 8 to be heated by reboiler R1. The heated absorbent solution optionally partly vaporized in R1 is fed through line 9 to the bottom of column C2. Another fraction of the regenerated absorbent solution recovered in the bottom of C2 is discharged through line 12 in order to be reinjected into absorption column C1 via line 4.

According to the invention, another fraction of the regenerated absorbent solution is sent from C2 through line 8b to separation drum B1. Due to the heating undergone in C2, the regenerated absorbent solution is at a temperature above the critical temperature at which the regenerated absorbent solution divides into two phases: a liquid phase rich in reactive compounds and a water-rich liquid phase.

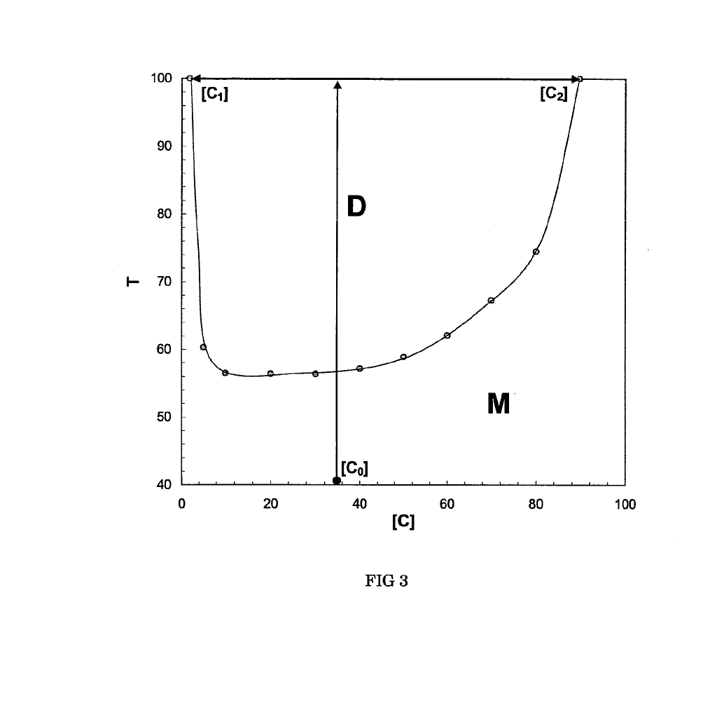

FIG. 3 illustrates the absorbent solution demixing phenomenon. This figure shows an example of evolution of the critical demixing temperature T as a function of the concentration [C] in reactive compound TMHDA (N,N,N′,N′-Tetramethylhexane-1,6-diamine) for an absorbent solution consisting of TMHDA in aqueous solution that has absorbed no acid compounds. Domain M indicates the temperature and concentration conditions for which the absorbent solution is a single-phase solution. Domain D indicates the temperature and concentration conditions for which the absorbent solution is a two-phase solution. At high temperature, the absorbent solution of global reactive compound concentration [C₀] is a two-phase solution (zone D) and it divides into two phases, one poor in reactive compounds (reactive compound concentration [C₁]) and the other rich in reactive compounds (reactive compound concentration [C₂]). When the absorbent solution is regenerated, the phase poor in reactive compounds essentially consists of water. This water-rich phase is used within the scope of the present invention for washing the gas released from the absorbent solution laden with acid compounds.

In device B1, the regenerated absorbent solution can be separated by decantation, centrifugation or filtration. B1 allows to separate the water-rich liquid phase from the liquid phase rich in reactive compounds. The separation operation in B1 can optionally be carried out at a different pressure than the pressure in C2 so as to facilitate said separation stage. For example, separation drum B1 can operate at a temperature ranging between 80° C. and 200° C., preferably between 100° C. and 160° C., and at a pressure ranging between 1 and 10 bars absolute, preferably between 1.5 and 7 bars absolute.

According to the invention, with reference to FIG. 1, the water-rich liquid phase is discharged from B1 through line 11 and fed to washing section L through line 11b. Optionally, the water-enriched liquid phase circulating in line 11 can be cooled in heat exchanger E3 to a temperature ranging between 10° C. and 70° C., preferably between 10° C. and 50° C. The water-enriched liquid phase recovered through line 11 is poor in amines and in acid compounds. This liquid phase is thus of excellent quality for washing gas 16a in order to recover the reactive compounds carried along by this gas.

The heat released by cooling the absorbent solution collected in the bottom of column C2 can be recovered for heating various streams to be regenerated. For example, with reference to FIG. 1, the absorbent solution circulating in line 12 allows to heat, in heat exchanger E1, the absorbent solution laden with acid compounds circulating in line 5. This solution circulating in line 12 is then cooled by exchanger E2 to the operating temperature of column C1, and fed to C1 through line 4.

According to another variant of the invention that is not shown, a tray P can be used between absorption section A and washing section L in order to recover the water-enriched liquid phase after washing section L. This phase contains the reactive compounds carried along by the gas. It is discharged by a pump to a storage tank where it is efficiently mixed with the liquid phase enriched in reactive compounds coming from B1 and circulating in line 10. A stirring system can optionally be arranged in the storage tank to facilitate mixing. The absorbent solution thus formed is sent to washing section A. In another variant of the invention, a fraction of the wafer-enriched liquid phase coming from washing section L can be recycled to the top of washing section L after being cooled in an exchanger. Recycling the water-enriched liquid phase from washing stage (L) allows to increase the water flow rate in section L so as to guarantee efficient washing of the washed gas. Tray P can be a distribution tray known to the person skilled in the art. The method schematized in FIG. 1 is well suited for deacidizing a gas. For example, it is suited for deacidizing a natural gas.

The nature of the reactive compounds of the absorbent solution can be selected depending on the nature of the acid compound(s) to be treated so as to allow a reversible chemical reaction with the acid compound(s) to be treated. Besides, the chemical structure of the reactive compounds can also be selected so as to obtain increased stability of the absorbent solution under the conditions of use.

The reactive compound(s) can be, by way of non limitative example, (primary, secondary, tertiary, cyclic or not, aromatic or not, saturated or not) amines, alkanolamines, polyamines, amino-acids, amino-acid alkaline salts, amides, ureas, alkali metal phosphates, carbonates or borates. For example, the following reactive compound can be used: N,N,N′,N′-tetramethylhexane-1,6-diamine, commonly referred to as TMHDA.

The reactive compound(s) can be in variable concentration in the aqueous solution. This concentration ranges for example between 10 wt. % and 90 wt. %, preferably between 15 wt. % and 60 wt. %, more preferably between 20 wt. % and 50 wt. %.

The absorbent solution can contain between 10 wt. % and 90 wt. % water, preferably between 40 wt. % and 85 wt. % water, and more preferably between 50 wt. % and 80 wt. % water.

In an embodiment, the reactive compound(s) of the absorbent solution can be mixed with another amine, containing at least one primary or secondary amine function so as to act as an activator. The absorbent solution can contain activator up to a concentration of 20 wt. %, preferably less than 15 wt. % and more preferably less than 10 wt. %.

This type of formulation is particularly interesting in the case of CO₂ capture in industrial fumes, or treatment of natural gas containing CO₂ above the desired specification. In fact, for this type of application, one wants to increase the CO₂ capture kinetics in order to reduce the size of the equipments.

The activator can be selected from the group made up of monoethanolamine (MEA), aminoethylethanolamine (AEEA), diglycolamine (DGA), piperazine, N-(2-hydroxyethyl)piperazine, N-(2-aminoethyl)piperazine, N-methylpiperazine, N-ethylpiperazine, N-propylpiperazine, 1,6-hexanediAmine, 1,1,9,9-tetramethyldipropylenetriamine, morpholine, piperidine, 3-(metylamino)propylamine, N-methylbenzylamine and 1,2,3,4-tetrahydrydrolisoquinoline.

In an embodiment, the absorbent solution, in particular an absorbent solution based on N,N,N′,N′-tetramethylhexane-1,6-diamine, can also contain other organic compounds. Thus, the absorbent solution according to the invention can contain organic compounds that are not reactive towards acid compounds (commonly referred to as “physical solvent”) and that allow to increase the solubility of at feast one or more acid compounds of the gaseous effluent. For example, the absorbent solution can contain between 5 wt. % and 50 wt. % of physical solvent such as alcohols, glycol ethers, lactames, N-alkylated pyrrolidones, N-alkylated piperidones, cyclotetramethylenesulfones, N-alkylformamides, N-alkylacetamides, ether-ketones or alkyl phosphates and derivatives thereof. By way of non limitative example, it can be methanol, tetraethyleneglycoldimethylether, sulfolane or N-formyl morpholine.

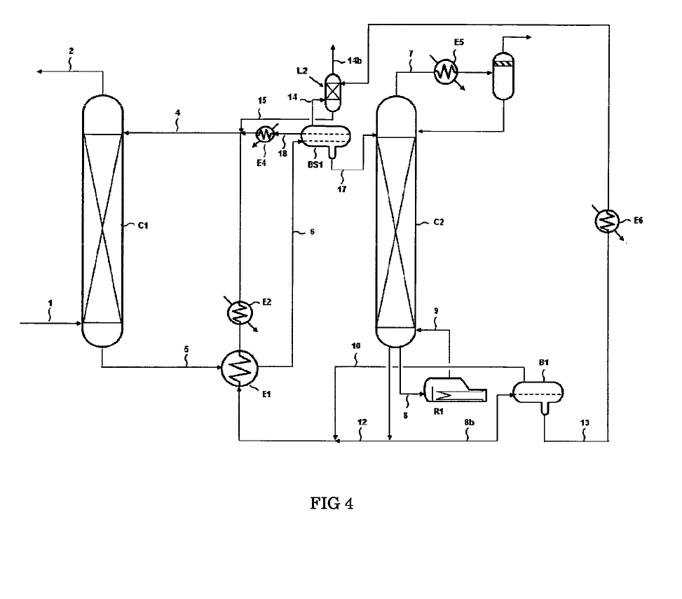

According to a variant of the invention, a washing section for a gas with a water-enriched liquid phase of the regenerated absorbent solution can be used in a gas feed deacidizing method, said method operating at low pressure. This method is shown in FIG. 4. The absorbent solution then has the specific feature of being a two-phase solution when it has absorbed acid compounds and has been heated. An absorbent solution separation stage upstream from column C2 then allows to partly regenerate the absorbent solution laden with acid compounds. However, the invention can also be applied in the case of a conventional method where the absorbent solution heated in the feed/effluent heat exchanger is a single-phase solution when it has absorbed a large amount of acid compounds. Stream 18 and heat exchanger E4 are Then not shown in the figure. The reference numbers of FIG. 4 identical to those of FIG. 1 designate the same elements.

With reference to FIG. 4, column C1 can operate at a temperature ranging between 30° C. and 90° C., preferably between 40° C. and 70° C., and at a pressure ranging between 1 and 100 bars absolute, preferably between 1 and 3 bars absolute. The absorbent solution laden with acid compounds obtained in the bottom of C1 and circulating in line 3 is heated in exchanger E1. It leaves exchanger E1 through line 6 at a higher temperature. In exchanger E1, the absorbent solution laden with acid compounds is heated until it exceeds the critical temperature at which the solution laden with acid compounds forms two separable liquid phases: a liquid phase rich in acid compounds and a liquid phase poor in acid compounds. For example, the absorbent solution laden with acid compounds is heated to a temperature ranging between 50° C. and 150° C., preferably between 70° C. and 120° C. Furthermore, under the effect of the temperature rise, part of the acid compounds is released in gas form. The three phases of the fluid circulating in line 6 are separated in separation drum BS1. For example, the two liquid phases are separated in drum BS1 by decantation, centrifugation or filtration. Separation drum BS1 can operate at a temperature ranging between 80° C. and 200° C., preferably between 100° C. and 160° C., and at a pressure ranging between 1 and 10 bars absolute, preferably between 1.5 and 7 bars absolute. The gas fraction obtained at the top of BS1 is extracted through line 14. Depending on the temperature at this point, gas stream 14 can contain reactive compounds entrained thermodynamically and mechanically in the gas containing acid compounds. According to the invention, a washing zone L2, a device (a column for example) separate from drum BS1, is used. Gas stream 14 is then contacted with the wafer-enriched liquid phase of the regenerated absorbent solution in washing zone L2. This water-enriched liquid phase flows in through line 13 and comes from drum B1 after cooling in exchanger E6. Drum B1 can operate at a temperature ranging between 80° C. and 200° C., preferably between 100° C. and 160° C., and at a pressure ranging between 1 and 10 bars absolute, preferably between 1.5 and 7 bars absolute. Zone L2 is equipped with gas/liquid contacting internals, for example distillation trays, a random or a stacked packing. Besides, the liquid phase enriched in acid compounds coming from separation drum BS1, i.e. enriched in reactive compounds that have reacted with the acid compounds, is sent through line 17 to regeneration column C2. Column C2 can operate at a temperature ranging between 80° C. and 200° C., preferably between 100° C. and 160° C., and at a pressure ranging between 1 and 10 bars absolute, preferably between 1.5 and 7 bars absolute. The liquid phase depleted in acid compounds, i.e. enriched in unreacted reactive compounds, is discharged from separation drum BS1 through line 18 and cooled in exchanger E4 prior to being recycled with the regenerated absorbent solution circulating in line 4. In a variant of the invention, all of the liquids obtained in drum BS1 are sent through line 17 to C2, line 18 and heat exchanger E4 being suppressed. The water-enriched liquid phase recovered at the outlet of washing zone L2 circulates in line (15) and is fed to column C1. It is first mixed with the fraction of the absorbent solution circulating in line 4. The method schematized in FIG. 4 is for example well suited for capture of the CO₂ contained in combustion fumes.

The method according to the present invention and its advantages are illustrated by the operating example below.

### EXAMPLES

The examples below relate to the deacidizing of a natural gas whose characteristics are shown in Table 1 using an absorbent solution containing 35 wt. % TMHDA.

TABLE 1

| Stream No. | 1 |
|---|---|
| Flow rate (kmol/h) | 13 695 |
| Temperature (° C.) | 35 |
| Pressure (bar a) | 60.2 |
| Composition (mol %) | |
| CO2 | 5.5 |
| H2S | 12 |
| CH4 | 81.7 |
| H2O | 0 |

### Example 1

### Method of Deacidizing without Washing with a Water-Enriched Liquid Phase of the Regenerated Absorbent Solution

After absorption of the acid gas, the absorbent solution laden with acid compounds leaves column C1 through stream 3 and it is sent to drum BF1 through expansion valve V1. Table 2 relates to streams 3 and 3b flowing into drum BF1 to be expanded.

TABLE 2

| Stream No. | 3 | 3b |
|---|---|---|
| Flow rate (kmol/h) | 41 865.2 | 41 865.2 |
| Temperature (° C.) | 41.1 | 40.9 |
| Pressure (bar a) | 60.2 | 8 |
| Phase | L | L + V |
| Composition (mol %) | | |
| CO2 | 1.8 | 1.8 |
| H2S | 4.17 | 4.17 |
| CH4 | 0.2 | 0.2 |
| H2O | 89.23 | 89.23 |
| TMHDA | 4.6 | 4.6 |

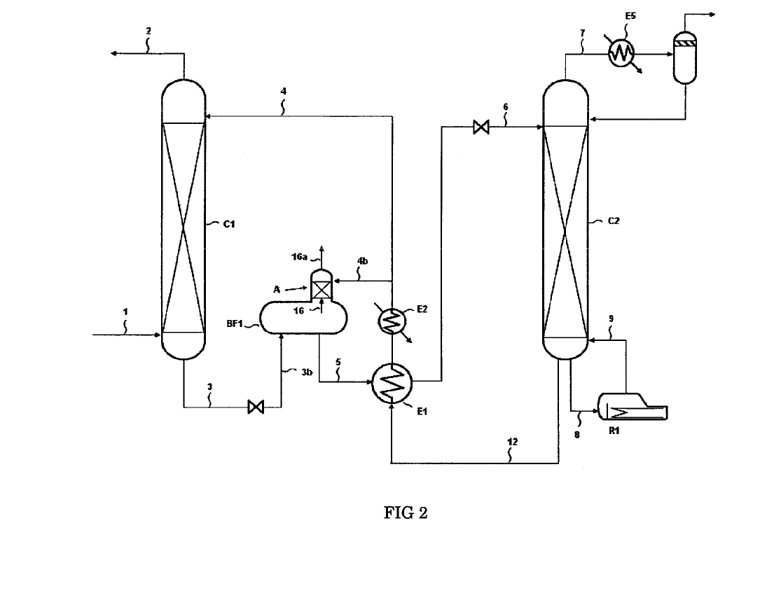

According to the prior art illustrated in FIG. 2, Example 1 describes a stage of expansion of stream 3b with washing of the expansion gas with the regenerated absorbent solution flowing in with stream 4b in order to meet the acid gas content of the expansion gas. There is no washing section (L) for washing the gas with a water-enriched liquid phase of the absorbent solution. Table 3 shows the TMHDA losses in the expansion gas in this case.

TABLE 3

| Stream No. | 3b | 16 | 16a | 4b |
|---|---|---|---|---|
| Flow rate (kmol/h) | 41 865.2 | 73.2 | 72.93 | 50 |
| Temperature (° C.) | 40.9 | 40.9 | 46.6 | 45 |
| Pressure (bar a) | 8 | 8 | 7.9 | 7.9 |
| Phase | L + V | V | V | L |
| Composition (mol %) | | | | |
| CO2 | 1.8 | 0.425 | 0.002 | — |
| H2S | 4.17 | 0.549 | 0.0066 | — |
| CH4 | 0.2 | 98.1 | 98.7 | — |
| H2O | 89.23 | 0.925 | 1.278 | 95.1 |
| TMHDA | 4.6 | 0.00028 | 0.0059 | 4.9 |

### Example 2

### Deacidizing Method According to the Invention Comprising a Washing Section (L) with a Water-Enriched Liquid Phase of the Absorbent Solution

Example 2 implements the method according to the invention illustrated in FIG. 1. After washing the expansion gas with mixture (4b), the gas washed in section (A) is washed a second time in section (L) with the water-enriched liquid phase of the regenerated absorbent solution circulating in line (11b) and coming from drum B1. Washing in section (L) allows the amine content of the gas to be reduced.

TABLE 4

| Stream No. | 3b | 16 | 16a | 4b | 16b | 11b |
|---|---|---|---|---|---|---|
| Flow rate | 41 865.2 | 73.2 | 72.93 | 50 | 72.93 | 50 |
| (kmol/h) | | | | | | |
| Temper- | 40.9 | 40.9 | 46.6 | 45 | 45 | 45 |
| ature (° C.) | | | | | | |
| Pressure | 8 | 8 | 7.9 | 7.9 | 7.9 | 7.9 |
| (bar a) | | | | | | |
| Phase | L + V | V | V | L | V | |
| Compo- | | | | | | |
| sition | | | | | | |
| (mol %) | | | | | | |
| CO2 | 1.8 | 0.425 | 0.002 | — | 0.002 | — |
| H2S | 4.17 | 0.549 | 0.0066 | — | 0.0066 | — |
| CH4 | 0.2 | 98.1 | 98.7 | — | 98.7 | — |
| H2O | 89.23 | 0.925 | 1.278 | 95.1 | 1.278 | 100 |
| TMHDA | 4.6 | 0.00028 | 0.0059 | 4.9 | 2.75 | — |

The advantage of the invention appears clearly here. The TMHDA content of the expansion gas has decreased from 59 ppm to 0.27 ppm.

1) A method of deacidizing a gas feed comprising at least one acid compound, wherein the following stages are carried out:
a) contacting said feed with an absorbent solution comprising at least one reactive compound so as to obtain a gaseous effluent depleted in acid compounds and an absorbent solution laden with acid compounds, the absorbent solution being selected for its property of forming two liquid phases when heated,
b) releasing a gaseous effluent comprising acid compounds from the absorbent solution laden with acid compounds,
c) thermally regenerating at least part of the absorbent solution obtained in stage (b) so as to release the acid compounds in gas form and to obtain a regenerated absorbent solution,
d) recycling at least a first fraction of the regenerated absorbent solution obtained in stage (c) as the absorbent solution of stage (a),
e) separating at least a second fraction of the regenerated absorbent solution obtained in stage (c) into a water-enriched liquid phase and a liquid phase enriched in reactive compounds,
f) contacting the gaseous effluent obtained in stage (b) with said water-enriched liquid phase so as to obtain a gaseous effluent depleted in reactive compounds.

2) A method as claimed in claim 1, characterized in that stage (b) is carried out by heating the absorbent solution laden with acid compounds.

3) A method as claimed in claim 2, characterized in that it comprises a stage of separating the heated absorbent solution into a liquid phase depleted in acid compounds and a liquid phase enriched in acid compounds, and wherein the liquid phase enriched in acid compounds is recycled to stage (c) and the liquid phase depleted in acid compounds is recycled to stage (d).

4) A method as claimed in claim 2, characterized in that the heating stage is carried out at a temperature ranging between 50° C. and 150° C.

5) A method as claimed in claim 1, characterized in that stage (b) is carried out through expansion of the absorbent solution laden with acid compounds.

6) A method as claimed in claim 5, characterized in that it comprises, prior to stage (f), a washing stage wherein the gaseous effluent is contacted with the liquid phase enriched in reactive compounds obtained in stage (e) mixed with the water-enriched liquid phase from stage (f) so as to obtain a gaseous effluent depleted in acid compounds.

7) A method as claimed in claim 1, characterized in that the water-enriched liquid phase is recovered at the end of stage (f).

8) A method as claimed in claim 7, characterized in that a fraction of the water-enriched liquid phase obtained at the end of washing stage (f) is recycled to stage (f).

9) A method as claimed in claim 7, characterized in that a fraction of the water-enriched liquid phase obtained at the end of washing stage (f) is recycled to stage (d).

10) A method as claimed in claim 1, characterized in that the separation stages are conducted according to one of the following separation techniques: decantation, centrifugation or filtration.

11) A method as claimed in claim 1, characterized in that at least one reactive compound of the absorbent solution is selected from the group consisting of amines, alkanolamines, polyamines, amino-acids, amino-acid alkaline salts, amides, ureas, alkali metal phosphates, carbonates and borates.

12) A method as claimed in claim 1, characterized in that said gas feed is selected from the group made up of natural gas, syngas, combustion fumes, refinery gas, Claus tail gas and biomass fermentation gas.
